(19) United States
(12) Patent Application Publication
(10) Pub. No.: US 2025/0137978 A1
(43) Pub. Date: May 1, 2025

(54) Sensor assembly for monitoring the structure of a housing structure

(71) Applicant: HELLA GmbH & Co. KGaA, Lippstadt (DE)

(72) Inventors: Thomas Niemann, Delmenhorst (DE); Hauke Baumgärtel, Ganderkesee (DE)

(21) Appl. No.: 18/934,642

(22) Filed: Nov. 1, 2024

(30) Foreign Application Priority Data
Nov. 1, 2023 (DE) 102023130199.3

(51) Int. Cl. G01N 29/44; G01N 29/04

(52) U.S. Cl. CPC G01N 29/4454; G01N 29/04; G01N 2291/269

(57) ABSTRACT

A sensor assembly, for monitoring the structure of a housing structure for holding fluid or solid media with an outer casing, has a central control unit designed to generate and receive structure-borne sound signal patterns. The sensor assembly includes at least one transmitter unit separated spatially from the central control unit. The at least one transmitter unit is designed to generate and receive structure-borne sound signal patterns. The central control unit has at least one evaluation unit for evaluating the structure-borne sound signal patterns emitted by the transmitter units.

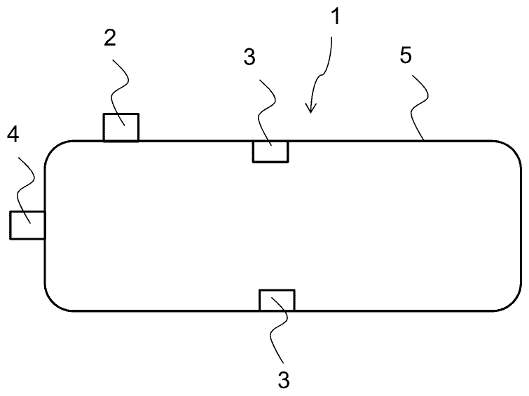

### BACKGROUND OF THE INVENTION

The invention relates to a sensor assembly for monitoring the structure of a housing structure for holding fluids or solid media with an outer casing. The invention further relates to a method for monitoring the structure of a housing structure for holding fluids or solid media with an outer casing. A housing structure with an outer casing may be for example a tank for a motor vehicle. In particular, it may be a hydrogen tank which has an outer casing made from a fibre-reinforced plastic, for example glass-fibre-reinforced plastic or carbon-fibre-reinforced plastic. In addition, an inner, gas-impermeable lining, made from PTFE for example, may be arranged inside the outer casing for direct retention of a fluid medium. Such materials are extremely durable, and even suitable for permanent operation in a motor vehicle, but material fatigue in cyclic operation or accident-related effects can result in damage to the housing structure. In the case of hydrogen tanks, for example, damage to the housing structure may result in the escape of hydrogen, creating a high potential for danger.

Hydrogen-leakage sensors, for example, are known for detecting an escape of hydrogen. In this situation, for example, hydrogen content may be detected in the ambient air. The drawback of this method is that a warning can only be issued as soon as an escape of hydrogen has actually taken place.

### SUMMARY OF THE INVENTION

The object underlying the invention is to suggest a sensor system and a method which make it possible to detect cases of weakening and possible damage in the housing structure before the medium it holds escapes to the outside.

This object is solved with a sensor assembly, with a method, and with a housing structure.

Further developments and advantageous variants are specified in the subordinate claims.

In a sensor assembly for monitoring the structure of a housing structure for holding fluid or solid media with an outer casing, it is provided as essential to the invention that the sensor assembly has a central control unit, that the central control unit is designed to generate and receive structure-borne sound signal patterns, that the sensor assembly includes at least one transmitter unit, that the transmitter unit is separated spatially from the central control unit, that the at least one transmitter unit is designed to generate and receive structure-borne sound signal patterns, and that the central control unit has at least one evaluation unit for evaluating the structure-borne sound signal patterns emitted by the transmitter units.

The sensor assembly has a central control unit that is designed to emit and to receive structure-borne sound signal patterns. For this purpose, the central control unit may include a structure-borne sound sensor, for example, by which vibrations propagating on the housing structure may be detected. Vibrations may also be generated actively by the structure-borne sound sensor, and then propagate on the housing structure. For this purpose, for example piezoelectric elements or the like may be used as structure-borne sound sensors. Besides the central control unit, the sensor assembly has at least one, preferably multiple transmitter units. These transmitter units are separated spatially from the central control unit, in particular the central control unit and the transmitter units are each individual physical units that are separate from each other. The transmitter units are designed to generate and to receive structure-borne sound signal patterns, wherein for this purpose in particular they may include a structure-borne sound sensor, in the form of a piezoelectric element, for example. The central control unit and the transmitter unit may be arranged in different positions of the housing structure. In particular, the central control unit may be arranged outside of the housing structure, while the transmitter units are arranged on the inside of the housing structure, that is to say on the side of the housing structure facing the holding volume. Structure-borne sound signal patterns emitted by the transmitter units may be detected and evaluated by the central control unit for example. For the evaluation, the central control unit includes an evaluation unit, for example in the form of a computing unit, a microprocessor or the like. The structure-borne sound signal patterns may be examined for characteristic properties for example, such as characteristic frequencies, characteristic signal paths or the like, which provide an indication of structural changes in the housing structure. Changes to the structure-borne sound signal patterns emitted by the transmitter units can also be examined on the transmission route to the central control unit or the other way round. Characteristic signal patterns that suggest changes to the housing structure may be stored in a memory device, for example, to enable matching.

In a further development of the invention, the central control unit is designed to control the at least one transmitter unit by means of structure-borne sound signal patterns. The central control unit has at least one structure-borne sound sensor, by which structure-borne sound signal patterns can also be generated. The structure-borne sound sensor may be a piezoelectric element, for example. The structure-borne sound signal patterns generated by the central control unit propagate on the housing structure in the form of vibrations and can be detected by the transmitter units. In this way, the structure-borne sound signal patterns may be used to transmit data, by coding control commands in the signal patterns, in digital or analogue form, for example. In this way it is possible to control the transmitter units without the need to create additional data lines or a wireless connection, and without having to provide additional communication apparatuses in the central control unit or the transmitter units.

In a further development of the invention, the sensor assembly includes multiple transmitter units. Through the use of multiple transmitter units, which in particular may be distributed evenly on the housing structure, it is possible to monitor the entire housing structure even in the case of spatially very expansive housing structures. For example, structure-borne sound signal patterns may be transmitted from one transmitter unit to the next, which then in turn forwards the structure-borne sound signal pattern to the central control unit.

In a further development of the invention, at least one transmitter unit is designed to be arranged in the interior of the housing structure. At least one, preferably multiple transmitter units, are mounted inside, for example on the side of the outer wall of the housing structure facing the holding volume. The arrangement of the transmitter units in the interior of the housing structure enable both external and internal changes in the housing structure to be detected and transmitted to the central control unit.

In a variant of the invention, the central control unit is designed to be arranged on the outside of the housing structure. The arrangement of the central control unit on the outside enables data to be transmitted easily from the central control unit to a system for further processing, to an onboard computer of a motor vehicle, for example.

In a variant of the invention, at least one transmitter unit includes at least one structure-borne sound sensor, at least one processing device and at least one power supply. The transmitter units each include a structure-borne sound sensor, in particular in the form of a piezoelectric element, with which structure-borne sound signal patterns can also be generated and emitted. In order to process the structure-borne sound signal patterns received, the transmitter units are equipped with processing devices such as microcontrollers, for example, or other computing units. In this way, control commands that were transmitted from the central control unit to the transmitter units in the form of structure-borne sound signal patterns can be processed and implemented correspondingly. For example, the transmitter units may be instructed via control signals to emit special structure-borne sound signal patterns. Batteries, induction devices or the like may be provided to ensure power supply.

In a further development of the invention, at least one power supply is an energy harvesting device. Voltages and consequently energy may be generated by means of piezoelectric elements using the propagating vibrations, which can then be used to supply power to the respective transmitter unit. Thus, the transmitter units are completely autarchic, without the need to place lines for energy supply or the like.

A further aspect of the invention relates to a method for monitoring the structure of a housing structure intended to hold fluid or solid media, wherein the sensor assembly includes at least one central control unit and at least one transmitter unit, wherein the central control unit and the at least one transmitter unit are designed to generate and to receive structure-borne sound signal patterns, wherein at least one structure-borne sound signal pattern is emitted by means of the transmitter unit, wherein the structure-borne sound signal pattern emitted by the transmitter unit is received and evaluated by means of the central control unit, and a conclusion is drawn regarding the state of the housing structure from the structure-borne sound signal pattern received. The method for monitoring the structure of a housing structure is intended in particular to be used for early detection of structural changes that may lead to a weakening of the housing structure. In particular, in such an application a sensor assembly according to the invention may be implemented with a central control unit and multiple transmitter units. The central control unit and the transmitter units are designed to generate and to receive structure-borne sound signal patterns. In this context, it is possible to detect structure-borne sound signal patterns that arise while a motor vehicle is travelling or like and propagate on the housing structure, in particular on the tank that is to be monitored. Structure-borne sound signal patterns generated by the central control unit and the transmitter units may also be monitored and evaluated actively. Structure-borne sound signal patterns are generated by means of at least one transmitter unit, preferably by means of multiple transmitter units, for example by means of a piezoelectric element, in such manner that the structure-borne sound signal pattern propagates on the housing structure. The structure-borne sound signal pattern emitted by the transmitter unit is received by means of the central control unit and evaluated by means of an evaluation unit. A conclusion regarding the state of the housing structure can be drawn from the occurrence of characteristic signal patterns, characteristic frequencies, characteristic signal paths or the like. In this process, characteristic signal patterns that are known to indicate the existence of damage to the housing structure may be stored in a memory device for matching purposes. Changes to the structure-borne sound signal patterns, in particular in the development of the structure-borne sound signal patterns over time, may also be captured, wherein changes in the development over time indicate a change in the housing structure. The structure-borne sound signal patterns generated may be filtered out of the vibrations arising during operation, which constitute a kind of background noise, by means of algorithms. It may further be provided that a certain structure-borne sound signal pattern is emitted by a transmitter unit and said pattern is received by the central control unit, or vice versa. By comparing the known, emitted structure-borne sound signal pattern with the structure-borne sound signal pattern received by the central control unit, a conclusion can be drawn regarding the state of the housing structure. For example, the structure-borne sound signal pattern may change on the transmission route between transmitter unit and central control on the housing structure due to damage, in such manner that said damage is detectable because of the change. This makes it possible to detect damage to the housing structure early, before the fluid medium contained in the structure is able to leak out.

In a further development of the method, control commands in the form of structure-borne sound signal patterns are generated by the central control unit and transmitted to the transmitter units. Control commands coded in digital or analogue form may be sent by the central control unit to the transmitter units as structure-borne sound signal patterns, for example by wavelets, stationary waves, chirps or the like. In this way, the transmitter units may be activated for example to generate certain structure-borne sound signal patterns or similar. When the signal between the central control unit and the transmitter units is send by means of a structure-borne sound signal, it is not necessary to install additional data lines or the like for this purpose, so that the sensor assembly can be installed in the housing structure inexpensively.

In a further development of the method, a conclusion is drawn regarding the state of the housing structure from a difference between a structure-borne sound signal pattern emitted by the transmitter unit and the structure-borne sound signal pattern received by the central control unit. The structure-borne sound signal emitted by the transmitter is known, in particular this structure-borne sound signal pattern may have been initiated by a control command from the central control unit. A change in the housing structure or the state thereof may be suspected from a comparison of the expected signal pattern with the signal pattern received.

In a variant of the method, the sensor assembly includes multiple transmitter units. The housing structure is monitored on the basis of the structure-borne sound signal patterns sent back and forth between the transmitter units and the central control unit. A multiplicity of transmitter units, which may be arranged inside the housing structure, and between which structure-borne sound signal patterns are sent and received, enables monitoring of the housing structure over an expansive area. In this way, threats of damage can be detected in all areas of the housing structure.

The invention further relates to a housing structure for holding fluid or solid media with an outer casing, wherein the housing structure includes a sensor assembly according to the invention, wherein a central control unit is arranged on the outside of the housing structure, and wherein at least one transmitter unit is arranged inside the housing structure. A housing structure with an outer casing may be a tank for a motor vehicle, for example. In particular, the housing structure may have an external casing made from a fibre-reinforced plastic, for example glass-fibre reinforced plastic or carbon-fibre-reinforced plastic. Moreover, an inner, gas-impermeable lining, made from PTFE for example, may be arranged inside the outer casing for direct retention of a fluid medium. The central control unit and the transmitter units may be arranged in different positions on the housing structure. In particular, the central control unit may be arranged outside the housing structure, while the transmitter units may be arranged on the inside of the housing structure, that is to say facing the retention volume of the housing structure. Through the use of multiple transmitter units, which in particular may be distributed evenly over the housing structure, it is possible to assure monitoring of the entire housing structure even in the case of spatially very expansive housing structures.

### BRIEF DESCRIPTION OF THE DRAWINGS

In the following text, the invention will be explained further with reference to an exemplary embodiment represented in the drawing. In detail, the sole FIGURE shows a housing structure with a sensor assembly.

### DETAILED DESCRIPTION

The sole FIGURE represents a housing structure 1 with a sensor assembly consisting of a central control unit 2 and transmitter units 3. The housing structure 1 may be a hydrogen tank with a hydrogen valve 4. The transmitter units 3 are arranged on the inside of the outer casing 5 of the housing structure 1. The central control unit 2 is arranged on the outside of the outer casing 5.

1. A sensor assembly for monitoring the structure of a housing structure for holding fluid or solid media, with an outer casing,
wherein the sensor assembly has a central control unit,
wherein the central control unit is designed to generate and to receive structure-borne sound signal patterns,
wherein the sensor assembly has at least one transmitter unit,
wherein the transmitter unit is separated spatially from the central control unit,
wherein the at least one transmitter unit is designed to generate and receive structure-borne sound signal patterns, and
wherein the central control unit has at least one evaluation unit for evaluating the structure-borne sound signal patterns emitted by the transmitter units.

2. The sensor assembly according to claim 1, wherein the central control unit is designed to control the at least one transmitter unit by means of structure-borne sound signal patterns.

3. The sensor assembly according to claim 1, wherein the sensor assembly includes multiple transmitter units (3).

4. The sensor assembly according to claim 1, wherein at least one transmitter unit is designed to be arranged inside the housing structure.

5. The sensor assembly according to claim 1, wherein the central control unit is designed to be arranged on the outside of the housing structure.

6. The sensor assembly according to claim 1, wherein the transmitter units have at least one structure-borne sound sensor and/or at least one power supply and/or at least one processing device.

7. The sensor assembly according to claim 1, wherein the power supply is an energy harvesting device.

8. A method for monitoring the structure of a housing structure intended to hold fluid or solid media, wherein the sensor assembly has at least one central control unit and at least one transmitter unit,
wherein the central control unit and the at least one transmitter unit are designed to generate and to receive structure-borne sound signal patterns,
wherein at least one structure-borne sound signal pattern is emitted by means of the transmitter unit,
wherein the structure-borne sound signal pattern emitted by the transmitter unit is received and evaluated by means of the central control unit, and
wherein a conclusion is drawn regarding the state of the housing structure from the structure-borne sound signal patterns received.

9. The method according to claim 8, wherein control commands in the form of structure-borne sound signal patterns are generated by the central control unit and sent to the transmitter units.

10. The method according to claim 8, wherein a conclusion is drawn regarding the state of the housing structure from a difference between a structure-borne sound signal pattern emitted by the transmitter unit and the structure-borne sound signal pattern received by the central control unit.

11. The method according to claim 8, wherein the sensor assembly has multiple transmitter units, and that the housing structure is monitored on the basis of structure-borne sound signal patterns sent back and forth between the transmitter units and the central control unit.

12. A housing structure for holding fluid or solid media, having an outer casing, wherein the housing structure includes a sensor assembly according to the invention,
wherein a central control unit is arranged on the outside of the housing structure, and
wherein at least one transmitter unit is arranged inside the housing structure.
